(19) United States
(12) Patent Application Publication
(10) Pub. No.: US 2009/0183927 A1
(43) Pub. Date: Jul. 23, 2009

(54) METHOD FOR MEASURING THE USEFUL LOAD OF A TELEHANDLER

(75) Inventor: Tilo HUBER, Tiefenbach (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/345,958

(22) Filed: Dec. 30, 2008

(30) Foreign Application Priority Data
Jan. 22, 2008 (DE) 10 2008 000 120.1

(51) Int. Cl. G01G 19/10

(52) U.S. Cl. 177/141

(57) ABSTRACT

A method for measuring the useful load of a telehandler is indicated in which the useful load is calculated from the change of the axle load on the front axle or the rear axle compared with the unloaded condition of the vehicle, the distance of the useful load from the front axle or the rear axle having a defined value or the load-holding device of the telehandler being in a defined position.

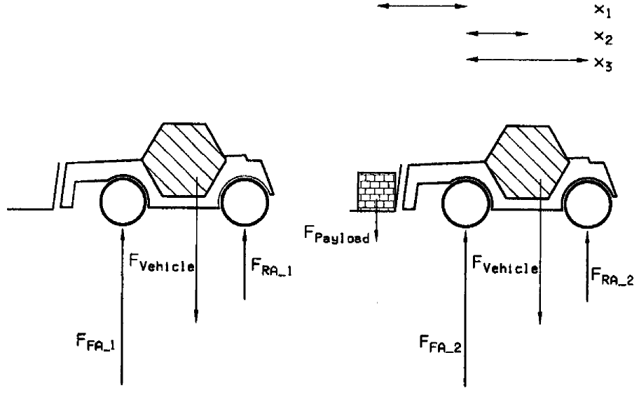

This application claims priority from German Application Serial No. 10 2008 000 120.1 filed Jan. 22, 2008.

### FIELD OF THE INVENTION

The present invention concerns a method for measuring the useful load of a telehandler according to the preamble of claim 1.

### BACKGROUND OF THE INVENTION

Telehandlers are commonly used in agriculture, building and the storage industry, and can be in the form of forklifts, wheel loaders, mobile cranes or working platforms.

From the prior art, it is known to recognize, by way of LMI (Load Movement Indicator), critical situations in the load curve such as excessively high loading and/or a load that is too wide and to warn the driver visually and/or acoustically. For this the strain at the rear axle brackets is measured and from that the rear axle load is determined. Depending on the rear axle load, the tilt stability of the telehandler is then concluded.

From DE 10 2006 010 291 A1, a floor-level transporter or telehandler is known, which comprises an electronic memory and/or a data transfer unit, a device for collecting working data and a control unit. The latter is connected to the working data collection device and to the memory and/or data transfer unit. In the known floor-level transporter, the control unit continuously prepares from the working data collected a working protocol and stores it in the memory or sends it to the data transfer unit. The working data collection device can comprise a load sensor to determine the weight of a load, which can be integrated in the load-holding means of the floor-level transporter. Alternatively, the weight of a load can be determined from an oil pressure in the hydraulic system of the transporter.

The propose of the present invention is to indicate a method for measuring the useful load of a telehandler, such that the useful load can be measured with great accuracy without the need for a separate load sensor.

### SUMMARY OF THE INVENTION

Accordingly, it is proposed to calculate the useful load from the change in the axle load on the front axle or the rear axle compared with the unloaded condition of the vehicle, with a defined distance between the useful load or load-holding device of the telehandler and the front axle or the rear axle, i.e., the load-holding device of the telehandler, which can be a scoop, a stacking fork, a gripper or a working platform, must be in a defined position.

In the distance between the useful load or load-holding device of the telehandler and the front or rear axle is kept constant, i.e., when the load-holding device is in a defined position, the useful load is proportional to the change of the axle load of the front or rear axle.

The concept according to the invention provides a method for measuring the useful load that is simple to carry out and gives accurate results. The useful load calculated can be shown by a suitable indicator device or display.

According to another embodiment of the invention, the method can be combined with LMI methods so that the useful load can be measured while at the same time critical load curve conditions can be recognized, since both methods make use of the same physical principle.

### BRIEF DESCRIPTION OF THE DRAWING

The invention will now be described, by way of example, with reference to the accompanying drawings in which:

The sole FIGURE schematically illustrates the force situation in the case of an unloaded and a loaded telehandler.

### DETAILED DESCRIPTION OF THE INVENTION

The left-hand side of the FIGURE shows the force situation of an unloaded telehandler. Here, the axle load F_{FA}_{_{—}}₁ on the front axle is given by:

F_{FA}_{_{—}}₁=F_{vehicle}−[(F_{vehicle}*x₂)/x₃]

where F_{vehicle}=weight of the vehicle, x₂=distance between the front axle and the vehicle's center of gravity and x₃=distance between the front axle and the rear axle. In the FIGURE, the axle load on the rear axle is indexed F_{RA}_{_{—}}₁.

The axle load F_{FA}_{_{—}}₂ on the front axle when the vehicle is loaded, as illustrated on the right in the FIGURE, is obtained as:

F_{FA}_{_{—}}₂=F_{vehicle}+F_{Payload}−[(F_{vehicle}*x₂−F_{payload}*x₁)/x₃]

where F_{vehicle}=vehicle weight, F_{Payload}=useful load, x₁=distance of the useful load from the front axle, x₂=distance between the front axle and the vehicle's center of gravity and x₃=distance between the front and rear axles. The axle load on the rear axle is indexed F_{RA}_{_{—}}₂.

From the above, the change ΔF_{FA} of the axle load on the front axle that results from loading is given by:

ΔF_{FA}=F_{Payload}−[(F_{vehicle}*x₂−F_{payload}*x₁)/x₃]+[(F_{vehicle}*x₂)/x₃]

ΔF_{FA}*x₃−F_{Payload}*x₃=F_{Payload}*x₁

and ΔF_{FA}*x₃=F_{Payload}*(x₁+x₃)

From this, it follows that the useful load F_{Payload} is:

F_{Payload}=ΔF_{FA}*[x₃/(x₁+x₃)]

This means that when the distance x₁ of the useful load or the load-holding device of the telehandler from the front axle is kept constant, the useful load is proportional to the change of the axle load on the front axle so that, in this case, simple and accurate measurement of the useful load is made possible. Advantageously, a displacement of the vehicle's center of gravity that results from a useful load does not influence the calculation of the useful load in accordance with the invention.

### REFERENCE NUMERALS

F_{FA}_{_{—}}₁ axle load on the front axle of an unloaded vehicle
F_{FA}_{_{—}}₂ axle load on the front axle of a loaded vehicle
F_{RA}_{_{—}}₁ axle load on the rear axle of an unloaded vehicle
F_{RA}_{_{—}}₂ axle load on the rear axle of a loaded vehicle
F_{vehicle} weight of the vehicle
F_{Payload} useful load
x₁ distance between the useful load and the front axle
x₂ distance between the front axle and the vehicle's center of gravity
x₃ distance between the front axle and the rear axle

1-4. (canceled)

5. A method for measuring a useful load of a telehandler, the method comprising the steps of calculating the useful load from a change of an axle load on one of the front axle or the rear axle compared with an unloaded condition of the vehicle, a distance of the useful load from one of the front axle or the rear axle having a defined value or a load-holding device of the telehandler being in a defined position.

6. The method for measuring the useful load of a telehandler according to claim 5, further comprising the step of calculating the useful load (F_{Payload}) with the equation:
F_{Payload}=ΔF_{FA}*[x₃/(x₁+x₃)]
where x₁=a distance of the useful load from the front axle, x₂=a distance between the front axle and the vehicle's center of gravity, and x₃=distance between the front and rear axles and ΔF_{FA}=a change of the axle load on the front axle, the distance (x₁) of the useful load or the load-holding device of the telehandler from the front axle being kept constant.

7. The method for measuring the useful load of a telehandler according to claim 5, further comprising the step of combining the method with LMI methods, so that the useful load can be measured and at the same time critical load curve situations can be recognized.

8. The method for measuring the useful load of a telehandler according to claim 5, further comprising the step of communicating the calculated useful load directly by one of a suitable indicator device or display.

9. A method of measuring a useful load of a telehandler, the method comprising the steps of
calculating the useful load on a front axle of the telehandler when the telehandler is unloaded;
calculating the useful load on the front axle of the telehandler when the telehandler is loaded;
determining a change in the useful load on the front axle of the telehandler from when the telehandler is unloaded to when the telehandler is loaded; and
calculating the useful load of the telehandler from the change in the useful load on the telehandler.
